(19) United States
(12) Patent Application Publication
(10) Pub. No.: US 2016/0370205 A1
(43) Pub. Date: Dec. 22, 2016

(54) POSITION DETECTING DEVICE AND IMAGE STABILIZATION DEVICE

(71) Applicant: Panasonic Intellectual Property Management Co., Ltd., Osaka (JP)

(72) Inventor: TSUTOMU YOSHIKAWA, Nara (JP)

(21) Appl. No.: 15/255,140

(22) Filed: Sep. 2, 2016

Related U.S. Application Data
(63) Continuation of application No. PCT/JP2015/004334, filed on Aug. 28, 2015.

(30) Foreign Application Priority Data
Sep. 25, 2014 (JP) 2014-195437

(51) Int. Cl. G01D 5/20; H04N 5/232

(52) U.S. Cl. CPC G01D 5/20; H04N 5/23264

(57) ABSTRACT

The position detecting device includes a permanent magnet unit having magnetic pole areas of N-pole and S-pole in a surface thereof, and a magnetic detection device apart from the surface by a distance. The permanent magnet unit has a main magnet element, and an auxiliary magnet element that is located closer to the magnetic detection device. The auxiliary magnet element has an N-pole auxiliary magnet part with the N-pole in the side of the surface and an S-pole auxiliary magnet part with the S-pole in the side of the surface. The main magnet element has an N-pole main magnet part on a side of the N-pole auxiliary magnet part and an S-pole main magnet part on a side of the

S-pole auxiliary magnet part. The magnetic detection device is relatively movable in a direction tilted with respect to an area boundary plane that separates magnetic poles of a magnetic field generated by the permanent magnet unit, while keeping the distance. The N-pole auxiliary magnet part and the S-pole auxiliary magnet part are disposed apart from each other by a gap, and the gap is larger than a gap between the N-pole main magnet part and the S-pole main magnet part.

### BACKGROUND

1. Technical Field

The disclosure relates to a position detecting device using a magnet structure and a magnetic detection device, and especially relates to a highly accurate and improved position detecting device for enlarging a linearity range of an output of magnetic detection means while increasing magnetic flux density of a composite magnetic field in a position detecting area.

2. Description of the Related Art

Patent Literature 1 discloses a position detecting device that enlarges a range in which magnetic flux density varies linearly. The position detecting device includes a permanent magnet unit having a permanent magnet with two magnetized poles. A magnet structure is configured in such a manner that auxiliary magnetic materials or auxiliary magnets are disposed apart from the permanent magnet and their centers each are positioned to deviate outwardly from a peak position of a magnetic field emitted from the respective magnetic poles of the permanent magnet. The position detecting device further includes magnetic detection means that moves, relative to the permanent magnet, in a space between the permanent magnet and auxiliary magnetic materials or auxiliary magnets, and detects a magnetic field of the permanent magnet. Thus, the peak positions of the magnetic field are shifted to separate from each other, thereby enlarging a linearity area of a composite magnetic field generated in between two poles.

### CITATION LIST

### Patent Literature

PTL1: Unexamined Japanese Patent Publication No. 2007-225575

### SUMMARY

The present disclosure proposes a position detecting device that increases magnetic field intensity while having a simple magnet structure and enlarges a linearity area of a composite magnetic field generated in between two poles.

The position detecting device in the present disclosure includes a permanent magnet unit having magnetic pole areas of N-pole and S-pole in a surface thereof, and a magnetic detection device apart from the surface of the permanent magnet unit by a distance. The permanent magnet unit has a main magnet element, and an auxiliary magnet element that is located closer to the magnetic detection device than the main magnet element is. The auxiliary magnet element has an N-pole auxiliary magnet part with the N-pole in the side of the surface and an S-pole auxiliary magnet part with the S-pole in the side of the surface. The main magnet element has an N-pole main magnet part on a side of the N-pole auxiliary magnet part and an S-pole main magnet part on a side of the S-pole auxiliary magnet part. The magnetic detection device is relatively movable in a direction tilted with respect to an area boundary plane that separates magnetic poles of a magnetic field generated by the permanent magnet unit, while keeping the distance from the permanent magnet unit. The N-pole auxiliary magnet part and the S-pole auxiliary magnet part are disposed apart from each other by a gap, and the gap is larger than a gap between the N-pole main magnet part and the S-pole main magnet part.

The position detecting device in the present disclosure can enlarge a linearity area of a composite magnetic field while increasing magnetic field intensity with a simple structure.

### BRIEF DESCRIPTION OF DRAWINGS

FIG. 1 is a perspective view of a position detecting device in accordance with a first exemplary embodiment.

FIG. 2 is a schematic diagram showing a movement of a magnetic detection device relative to a permanent magnet unit of the position detecting device in accordance with the first exemplary embodiment.

FIG. 3 is an explanatory diagram of a composite magnetic field in the position detecting device of the first exemplary embodiment.

FIG. 4 is a perspective view of a position detecting device in accordance with a second exemplary embodiment.

FIG. 5 is a front view of the position detecting device in accordance with the second exemplary embodiment. FIG. 6 is a perspective view of a position detecting device in accordance with a third exemplary embodiment.

FIG. 7A is a perspective view of a position detecting device in accordance with another exemplary embodiment (first modification example).

FIG. 7B is a front view of the position detecting device in accordance with another exemplary embodiment (first modification example).

FIG. 8A is a perspective view of a position detecting device in accordance with another exemplary embodiment (second modification example).

FIG. 8B is a front view of the position detecting device in accordance with another exemplary embodiment (second modification example).

FIG. 9A is a perspective view of the position detecting device including driving means in accordance with another exemplary embodiment.

FIG. 9B is an explanatory diagram of the position detecting device shown in FIG. 9A.

FIG. 10 is a view showing magnetic flux density curves of the exemplary embodiments.

FIG. 11 is a view showing a method of calculating linearity (linearity index).

### DETAILED DESCRIPTION OF THE PREFERRED EMBODIMENTS

Hereinafter, exemplary embodiments will be described in detail with reference to the drawings as necessary. Note that, unnecessary detail description may be omitted. For instance, detail description of well-known matters or overlapped description of the substantially same configuration may be omitted. This is because that the following description is avoided from being redundant unnecessarily and understood easily by those skilled in the art.

Note that, the accompanying drawings and the following description is proposed in order for those skilled in the art to fully understand the present disclosure, but not intended to limit subject matter recited in claims.

### First Exemplary Embodiment

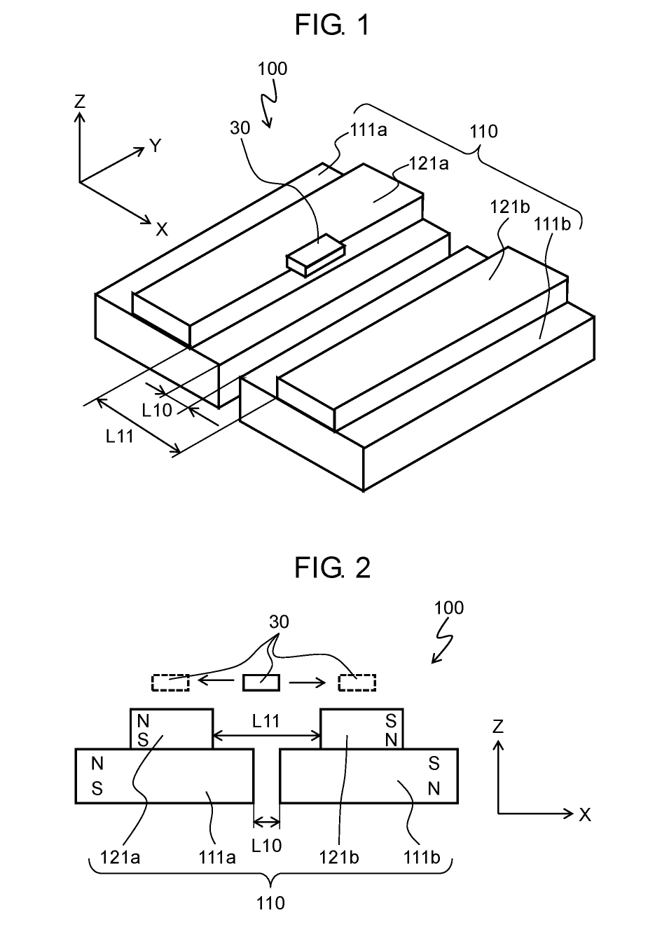

Hereinafter, using FIGS. 1 to 3, position detecting device 100 in accordance with a first exemplary embodiment will be described.

### [1-1. Structure]

FIG. 1 is a schematic perspective view schematically showing a structure of position detecting device 100 in the first exemplary embodiment. Position detecting device 100 includes permanent magnet unit 110 and magnetic detection device 30. Permanent magnet unit 110 is constituted by main magnets 111a (N-pole main magnet part), 111b (S-pole main magnet part) and auxiliary magnets 121a (N-pole auxiliary magnet part), 121b (S-pole auxiliary magnet part). Main magnets 111a, 111b and auxiliary magnets 121a, 121b of permanent magnet unit 110 each are constituted as a separate body. In permanent magnet unit 110, main magnets 111a, 111b constitute a main magnet element and auxiliary magnets 121a, 121b constitute an auxiliary magnet element.

Main magnets 111a, 111b are magnetized in a direction perpendicular to a plane area in which magnetic detection device 30 moves. Directions of magnetic flux from main magnets 111a, 111b are opposite to each other, and desirably differ from each other by 180 degree. Auxiliary magnets 121a, 121b are disposed in direct contact with upper surfaces of main magnets 111a, 111b. Directions of magnetic flux from auxiliary magnets 121a, 121b are the same as those of the magnetic flux from main magnets 111a, 111b respectively. Magnetic detection device 30 is disposed above permanent magnet unit 110 configured in such a manner. Now, the space between auxiliary magnet 121a and auxiliary magnet 121b, which is a magnetic gap, is wider than the gap between main magnet 111a and main magnet 111b. Herein, the gap between main magnet 111a and main magnet 111b and the gap between auxiliary magnet 121a and auxiliary magnet 121b are preferably determined to satisfy the following conditional expression (1):

L10<L11 (1)

where L10 is a gap distance between the main magnets, and L11 is a gap distance between the auxiliary magnets.

Note that, main magnet 111a and main magnet 111b may be in direct contact with each other, or may be separated by a magnetic gap. Further, a yoke (not shown) may additionally be attached to an opposite side of main magnets 111a, 111b with respect to magnetic detection device 30 as necessary.

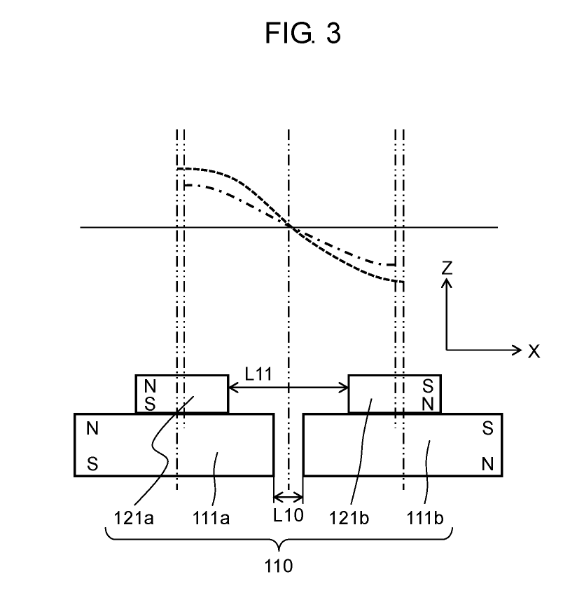

FIG. 2 is a schematic diagram showing a movement of magnetic detection device 30 in the first exemplary embodiment. Permanent magnet unit 110 is used as magnetic field generating means. Magnetic detection device 30 moves in the magnetic field generated from each magnetic pole of permanent magnet unit 110 to detect magnetic flux density in Z direction.

More specifically, magnetic detection device 30 moves in above auxiliary magnets 121a, 121b (in a space apart from auxiliary magnets 121a, 121b in Z direction) relatively with respect to permanent magnet unit 110 in approximately X direction, and then generates an output voltage depending on the magnetic flux density in Z direction that is detected at a goal position thereof. This makes it possible to detect a relative position of magnetic detection device 30 to permanent magnet unit 110. That is, as shown in FIG. 2, magnetic detection device 30 moves relatively with respect to permanent magnet unit 110 in a direction approximately perpendicular to an area boundary plane that separates the magnetic poles in permanent magnet unit 110 (in X direction) and detects the magnetic flux density in Z direction, thereby detecting the position of magnetic detection device 30 relative to permanent magnet unit 110. Note that, even if magnetic detection device 30 moves in a direction tilted with respect to the area boundary plane, which separates the magnetic poles in permanent magnet unit 110, rather than approximately perpendicular to the area boundary plane, the position of magnetic detection device 30 relative to permanent magnet unit 110 will be detected.

### [1-2. Magnetic Detection Method]

A magnetic detection method using position detecting device 100 with the above configuration will be described below.

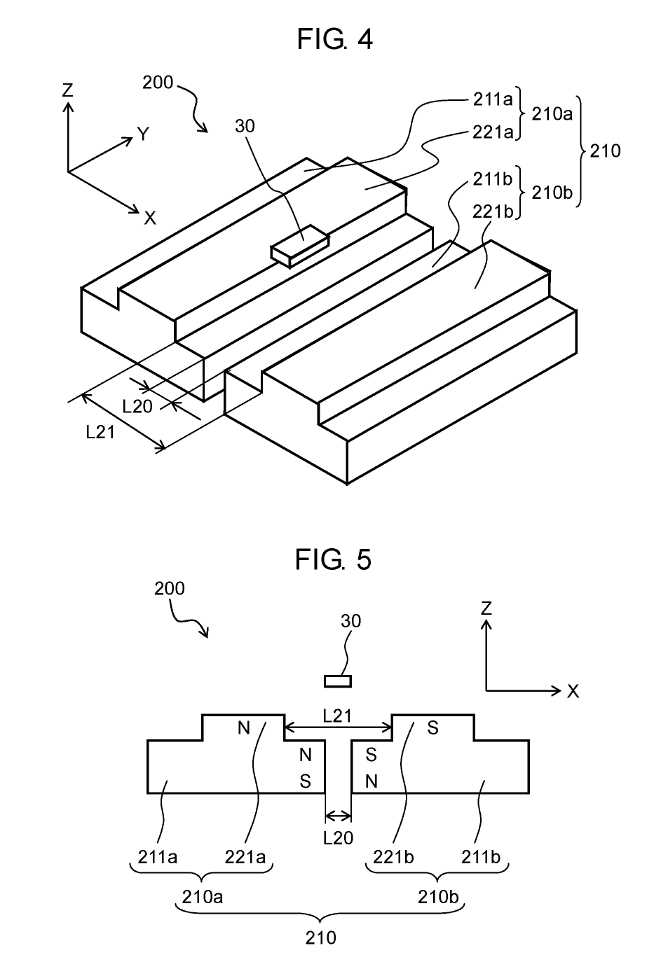

FIG. 3 shows magnetic flux density in Z direction along X direction in which magnetic detection device 30 disposed above permanent magnet unit 110 moves. Herein, the dashed line indicates a magnetic flux density curve in Z direction obtained by only main magnets 111a, 111b. Further, the long dashed short dashed line indicates a magnetic flux density curve obtained by only auxiliary magnets 121a, 121b. The figure shows that the respective curves have different trajectories. Thus, a sum of the above two curves corresponds to the entire composite magnetic field of permanent magnet unit 110 of position detecting device 100 in accordance with the first exemplary embodiment.

Note that, in permanent magnet unit 110 shown in FIG. 1, the length in Y direction of auxiliary magnets 121a, 121b is equivalent to that of main magnets 111a, 111b, but may be shorter than the length in Y direction of main magnets 111a, 111b. The composite magnetic field generated by main magnets 111a, 111b and auxiliary magnets 121a, 121b may be detected within a range in which magnetic detection device 30 moves relatively with respect to permanent magnet unit 110.

### [1-3. Effects]

As above, in position detecting device 100 in accordance with the first exemplary embodiment, auxiliary magnets 121a, 121b are disposed on main magnets 111a, 111b respectively, and magnetic detection device 30 is further disposed above auxiliary magnets 121a, 121b. This configuration ensures a wide range linearity of the composite magnetic field, thereby increasing magnetic flux density. Consequently, position detecting device 100 of the present disclosure can enlarge a position detectable area. Additionally, large enough magnetic field intensity can be obtained. This makes it possible to reduce errors due to influence of surrounding magnetic materials, thereby proposing a position detecting device with small errors. Further, if a yoke is disposed below main magnets 111a, 111b, larger magnetic flux density will be obtained.

### Second Exemplary Embodiment

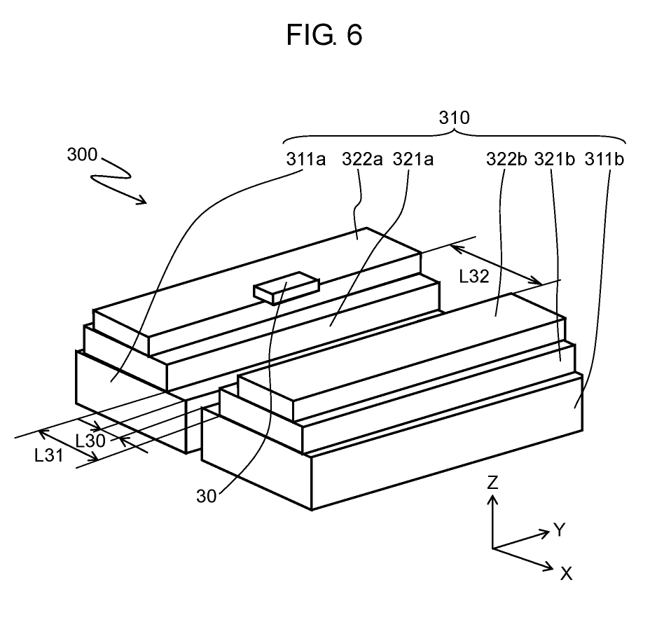

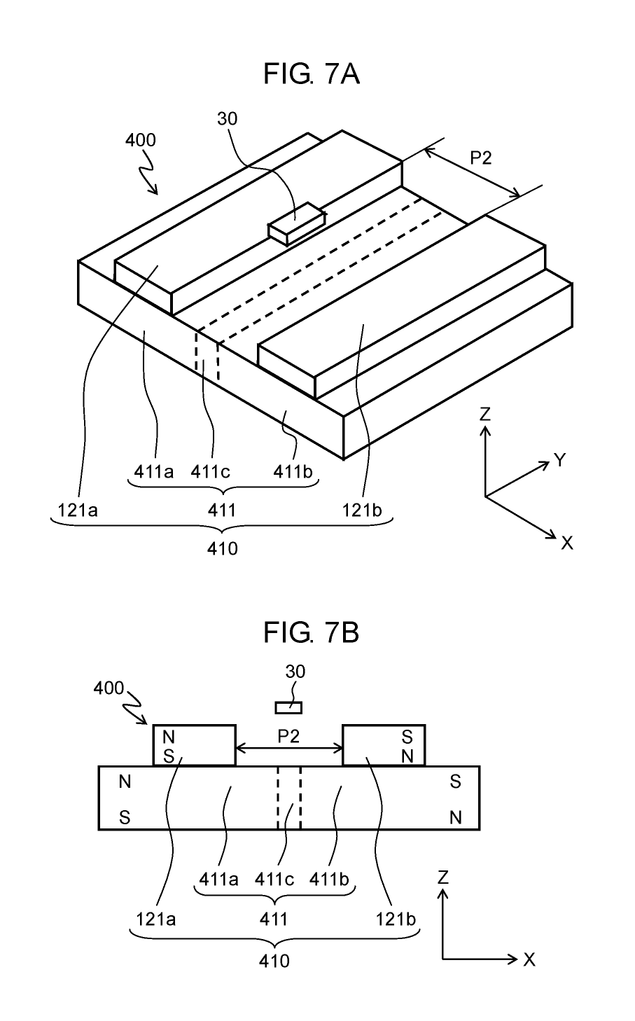

Hereinafter, position detecting device 200 in accordance with a second exemplary embodiment will be described using FIG. 4 and FIG. 5.

### [2-1. Structure]

FIG. 4 is a perspective view showing a structure of position detecting device 200. FIG. 5 is a front view showing a structure of position detecting device 200.

In permanent magnet unit 210 of position detecting device 200, main magnet 111a and auxiliary magnet 121a, which are described in the first exemplary embodiment, are integrated. Likewise, main magnet 111b and auxiliary magnet 121b, which are described in the first exemplary embodiment, are integrated. That is, permanent magnet 210a is formed by integrating main magnet 111a and auxiliary magnet 121a of permanent magnet unit 110 described in the first exemplary embodiment. Likewise, permanent magnet 210b is formed by integrating main magnet 111b and auxiliary magnet 121b. Then, permanent magnet 210a and permanent magnet 210b constitute permanent magnet unit 110.

As shown in FIG. 4, permanent magnet 210a is constituted by base part 211a (N-pole main magnet part) and auxiliary part 221a (N-pole auxiliary magnet part), and permanent magnet 210b is constituted by base part 211b (S-pole main magnet part) and auxiliary part 221b (S-pole auxiliary magnet part). Base parts 211a, 211b correspond to the main magnet element, and auxiliary parts 221a, 221b correspond to the auxiliary magnet element. As shown in FIG. 5, two permanent magnets 210a, 210b have a protruded cross section. Herein, the relationship of a gap between base parts 211a, 211b and a gap between auxiliary parts 221a, 221b is desired to satisfy the following conditional expression (2):

L20<L21 (2)

where L20 is a gap distance between the base parts, and L21 is a gap distance between the auxiliary parts.

Herein, base part 211a and base part 211b may be in direct contact with each other, or may be separated by a magnetic gap. Further, a yoke (not shown) may additionally be attached to an opposite side of permanent magnets 210a, 210b with respect to magnetic detection device 30 as necessary.

Furthermore, the length in Y direction of auxiliary parts 221a, 221b may be shorter than that of base parts 211a, 211b.

### [2-2. Effects]

As above, in the present exemplary embodiment, auxiliary parts 221a, 221b are disposed on base parts 211a, 211b respectively to constitute permanent magnet unit 210. Further, magnetic detection device 30 is disposed above permanent magnet unit 210. This configuration ensures a wide range linearity, thereby increasing magnetic flux density. Consequently, position detecting device 200 of the present disclosure can enlarge a position detectable area. Additionally, large enough magnetic field intensity can be obtained. This makes it possible to reduce errors due to influence of surrounding magnetic materials, thereby proposing position detecting device with small errors.

### Third Exemplary Embodiment

Hereinafter, a third exemplary embodiment will be described using FIG. 6.

### [3-1. Structure]

FIG. 6 is a schematic perspective view schematically showing a structure of position detecting device 300. Position detecting device 300 has permanent magnet unit 310 and magnetic detection device 30. Permanent magnet unit 310 has two main magnets 311a (N-pole main magnet part), 311b (S-pole main magnet part), first auxiliary magnets 321a (N-pole auxiliary magnet part), 321b (S-pole auxiliary magnet part) disposed on main magnets 311a, 311b respectively, and second auxiliary magnets 322a (N-pole auxiliary magnet part), 322b (S-pole auxiliary magnet part) disposed on the first auxiliary magnets 321a, 321b respectively. In permanent magnet unit 310, main magnets 311a, 311b constitute a main magnet element. Further, first auxiliary magnets 321a, 321b and the second auxiliary magnets 322a, 322b constitute an auxiliary magnet element.

Main magnets 311a, 311b are magnetized in a direction orthogonal to a plane area in which magnetic detection device 30 moves. Magnetic flux directions of main magnets 311a, 311b are opposite to each other in up-and-down direction (Z direction), and desirably differ from each other by 180 degree. Magnetic flux directions of first auxiliary magnets 321a, 321b disposed in direct contact with upper surfaces of main magnets 311a, 311b are the same as the magnetic flux directions of main magnets 311a, 311b respectively. Further, magnetic flux directions of second auxiliary magnets 322a, 322b disposed in direct contact with upper surfaces of first auxiliary magnets 321a, 321b are the same as the magnetic flux directions of first auxiliary magnets 321a, 321b respectively.

Now, a magnetic gap is provided between first auxiliary magnet 321a and first auxiliary magnet 321b. Likewise, a magnetic gap is provided between second auxiliary magnet 322a and second auxiliary magnet 322b. Herein, gap distance L31 between first auxiliary magnet 321a and first auxiliary magnet 321b and gap distance L32 between second auxiliary magnet 322a and second auxiliary magnet 322b are wider than gap distance L30 between main magnet 311a and main magnet 311b. Further, gap distance L32 between second auxiliary magnet 322a and second auxiliary magnet 322b is wider than gap distance L31 between first auxiliary magnet 321a and first auxiliary magnet 321b. Furthermore, gap distance L30 between main magnet 311a and main magnet 311b, gap distance L31 between first auxiliary magnet 321a and first auxiliary magnet 321b, and gap distance L32 between second auxiliary magnet 322a and second auxiliary magnet 322b are determined to satisfy the following conditional expression (3):

L30<L31≦L32 (3)

where L30 is a gap distance between the main magnets, L31 is a gap distance between the first auxiliary magnets, and L32 is a gap distance between the second auxiliary magnets.

Note that, as shown in conditional expression (3), gap distance L31 between first auxiliary magnet 321a and first auxiliary magnet 321b may be equal to gap distance L32 between second auxiliary magnet 322a and second auxiliary magnet 322b. Further, main magnets 311a, 311b may be in direct contact with each other, or may be separated by a magnetic gap. Furthermore, a yoke (not shown) may be additionally attached to an opposite side of main magnets 311a, 311b with respect to magnetic detection device 30 as necessary. Still further, the lengths in Y direction of the first auxiliary magnets 321a, 321b and the second auxiliary magnets 322a, 322b may be shorter than that of main magnets 311a, 311b. Still furthermore, any auxiliary magnets may be further disposed on the second auxiliary magnets 322a, 322b. The number of laminated auxiliary magnets may be more than this.

### [3-2. Effects]

In permanent magnet unit 310 in accordance with the third exemplary embodiment, first auxiliary magnets 321a, 321b and second auxiliary magnets 322a, 322b are disposed on main magnets 311a, 311b respectively. Further, magnetic detection device 30 is disposed above second auxiliary magnets 322a, 322b. This configuration ensures a wide range linearity, thereby increasing magnetic flux density. Consequently, position detecting device 300 of the present disclosure can enlarge a position detectable area. Additionally, large enough magnetic field intensity can be obtained. This makes it possible to reduce errors due to influence of surrounding magnetic materials, thereby proposing a position detecting device with small errors.

### Other Exemplary Embodiments

As above, the first, second, and third exemplary embodiments are described as an example of the technique disclosed in the present application. However, the technique of the present disclosure is not limited to this, but may be applied to exemplary embodiments in which modification, replacement, addition, omission, or the like are made. Further, the respective components described in the first, second, and third exemplary embodiments may be combined to configure a new exemplary embodiment. Hereinafter, other exemplary embodiments will be described as an example.

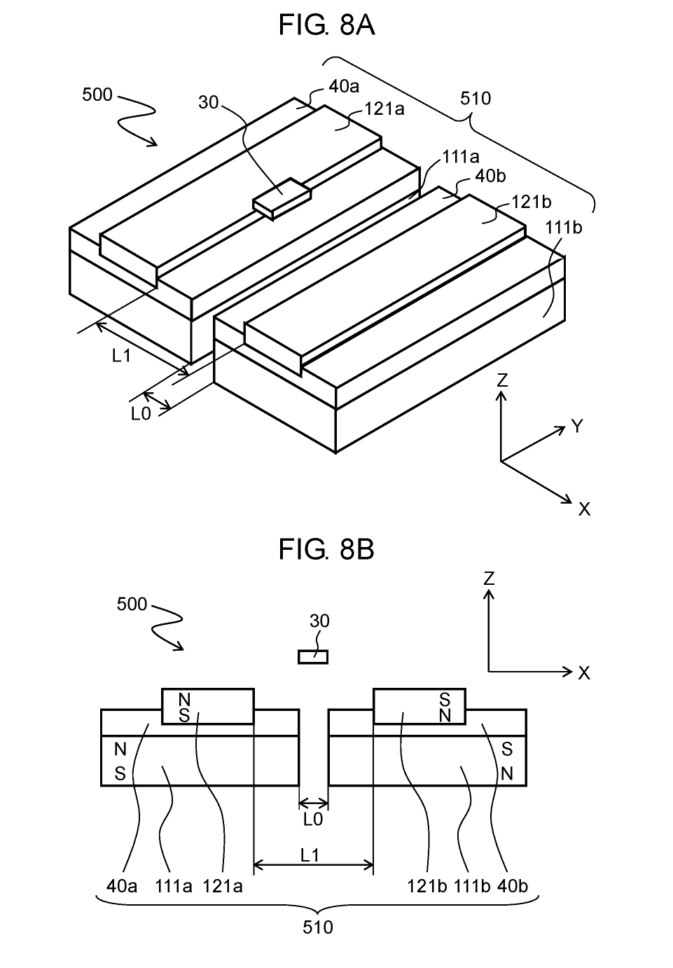

FIG. 7A is a schematic perspective view showing position detecting device 400 in accordance with a first modification example of the first exemplary embodiment. FIG. 7B is a front view of position detecting device 400 shown in FIG. 7A. The first modification example differs from the first exemplary embodiment in that main magnets 111a, 111b of the first exemplary embodiment are formed as a single main magnet 411.

Main magnet 411 (main magnet element) is a permanent magnet that is magnetized to have multiple poles. That is, main magnet 411 has non-magnetized area 411c located between first main magnet area 411a (N-pole main magnet part) and second main magnet area 411b (S-pole main magnet part). Herein, first main magnet area 411a and second main magnet area 411b each serve as a magnetized area. Auxiliary magnets 121a, 121b are disposed on one surface of main magnet 411 to configure permanent magnet unit 410. A gap (gap distance P2) between auxiliary magnets 121a, 121b is larger than a width (length in X direction) of non-magnetized area 411c.

Note that, as described in the second exemplary embodiment, main magnet 411 and auxiliary magnets 121a, 121b may be formed integrally as a permanent magnet.

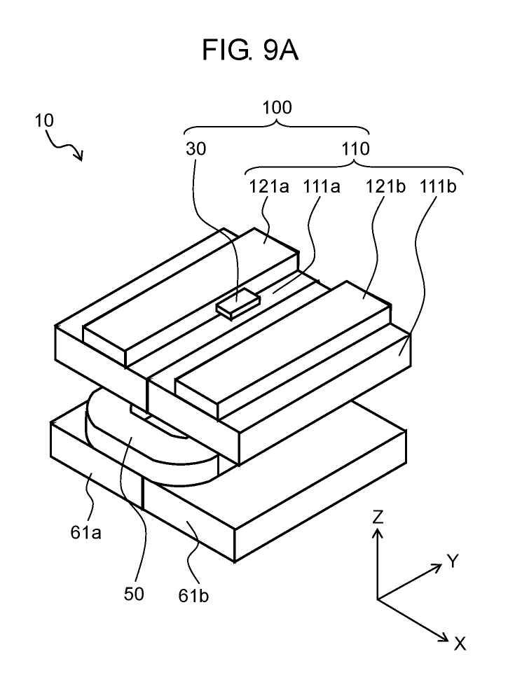

FIG. 8A is a schematic perspective view showing position detecting device 500 in accordance with a second modification example of the first exemplary embodiment. FIG. 8B is a front view of position detecting device 500 shown in FIG. 8A. Permanent magnet unit 510 of position detecting device 500 differs from permanent magnet unit 110 of the first exemplary embodiment in that thin spacers 40a, 40b are disposed between main magnet 111a and auxiliary magnet 121a and between main magnet 111b and auxiliary magnet 121b, respectively. Spacers 40a, 40b are desired to be a nonmagnetic material, but a very thin magnetic material, which is easy to reach magnetic saturation, may be used. Similarly to position detecting device 100 described in the first exemplary embodiment, gap distance L1 between auxiliary magnet 121a and auxiliary magnet 121b is also larger than gap distance L0 between main magnet 111a and main magnet 111b in position detecting device 500. The main magnet and the auxiliary magnet are not necessary to be in direct contact with each other like position detecting device 500. Even if the main magnet and the auxiliary magnet are contacted via a spacer or separated by a space, the same effects as the first exemplary embodiment will be obtained.

In position detecting device 500, as shown in FIGS. 8A and 8B, spacers 40a, 40b are disposed on the entire surface of main magnets 111a, 111b on an auxiliary magnet side, respectively. To position auxiliary magnets 121a, 121b with respect to main magnets 111a, 111b, spacers 40a, 40b are formed into a recessed shape into which each of auxiliary magnets 121a, 121b is to be inserted. Note that, spacers 40a, 40b may be disposed on only a portion in which each of auxiliary magnets 121a, 121b is to be disposed, instead of the entire surface of main magnets 111a, 111b on an auxiliary magnet side.

Further, main magnets 111a, 111b of position detecting device 500 may be formed integrally like main magnet 411 shown in the first modification example.

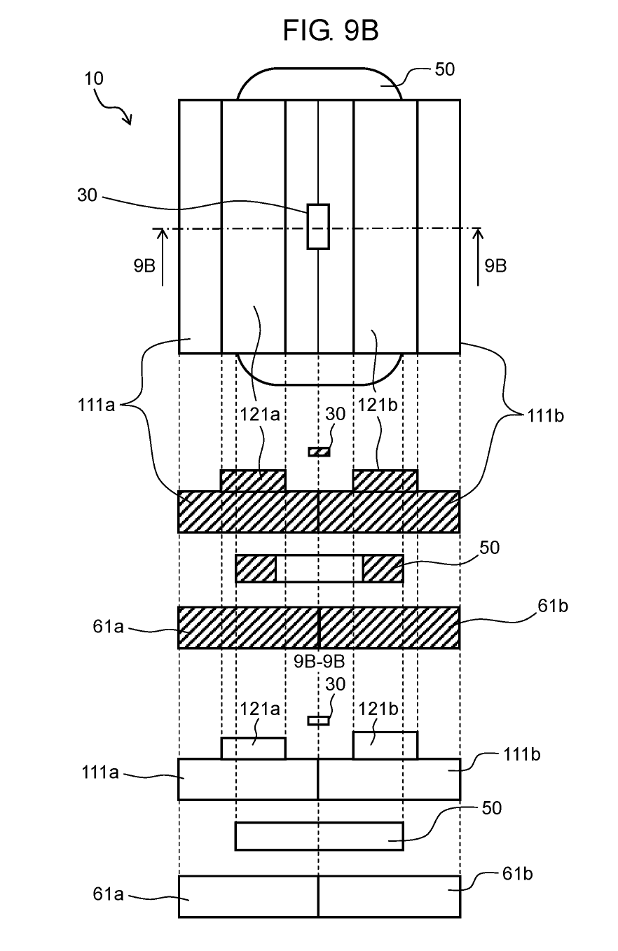

FIG. 9A is a schematic perspective view showing position detecting device 10 in which driving means for moving magnetic detection device 30 relatively with respect to permanent magnet unit 110 is added to position detecting device 100 of the first exemplary embodiment. FIG. 9B illustrates a plan view, a cross-sectional view, and a front view of position detecting device 10 shown in FIG. 9A. As the driving means, drive coil 50 may be employed. Drive coil 50 is disposed on an opposite side of main magnets 111a, 111b with respect to auxiliary magnets 121a, 121b. Thus, large driving force is obtained as compared with the case where only main magnets 111a, 111b are disposed.

Furthermore, to increase the driving force, facing magnets 61a, 61b may be employed as necessary. Facing magnets 61a, 61b are disposed on an opposite side (lower side in Z direction) of drive coil 50 with respect to main magnets 111a, 111b as shown in FIGS. 9A and 9B. Instead of facing magnets 61a, 61b, a facing yoke may be employed. Further, various kinds of actuators may be used for driving means, instead of drive coil 50.

### WORKING EXAMPLE

Hereinafter, to verify effects of the present disclosure, a verification experiment will be described.

NdFeB-based permanent magnet (10 mm×2 mm×1.5 mm) was used as a main magnet, and a main surface thereof (a surface of 10 mm×2 mm) was magnetized by a single pole. NdFeB-based permanent magnet (4 mm×1 mm×1 mm) was also used as an auxiliary magnet, and a main surface thereof (a surface of 4 mm×1 mm) was magnetized by a single pole.

Side faces of two main magnets extending in Y axial direction are directly contacted, and an iron yoke is further disposed on a back surface side of the two main magnets. At this time, the main magnets are disposed such that their magnetization directions are opposed to each other. The yoke has substantially the same size as the permanent magnet and its thickness is 1.0 mm. On an upper surface of each main magnet, an auxiliary magnet whose magnetization direction is aligned to that of the main magnet is disposed. Two auxiliary magnets each are apart from a contact face between the main magnets by distance d, and disposed plane-symmetrically. Gap distance L11 between the two auxiliary magnets is 2d.

### (Sample Pattern)

Samples 1 to 3 of the position detecting device were fabricated. The configuration of each sample is as follows:

Sample 1: without disposing any auxiliary magnet in an upper part of the main magnet, magnetic flux density in Z direction was measured at a height of 0.5 mm from the surface of the main magnet (first comparative example).

Sample 2: without disposing any auxiliary magnet in an upper part of the main magnet, magnetic flux density in Z direction was measured at a height of 3.4 mm from the surface of the main magnet (second comparative example).

Sample 3: auxiliary magnets were disposed in an upper part of the main magnet and separated from each other by a distance d of 0.4 mm, and then magnetic flux density in Z direction was measured at a height of 0.5 mm from the surface of the main magnet (working example).

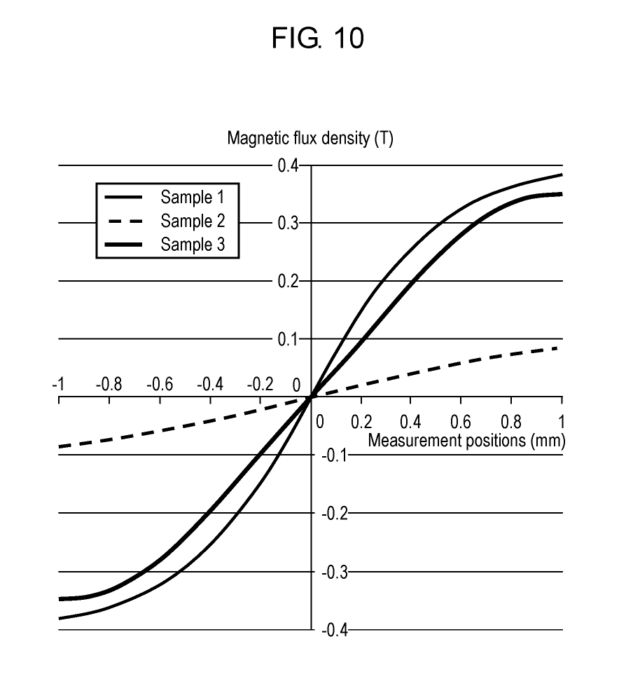

FIG. 10 shows results of measuring the magnetic flux densities of Samples 1 to 3. With respect to wave forms of these magnetic flux densities, linearity (linearity index) was measured. A method of measuring the linearity is as follows.

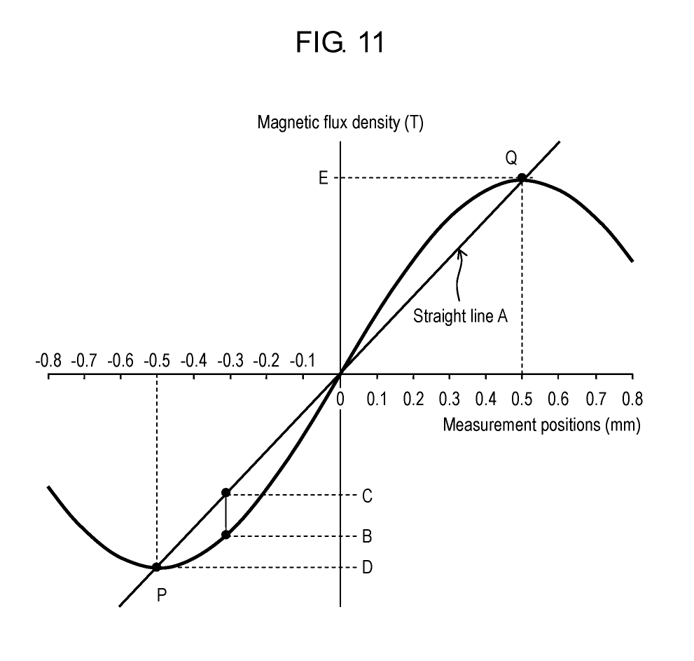

FIG. 11 is a view showing a method of measuring linearity. First, as shown in FIG. 11, point P and point Q are given on the graph which shows the result of measuring magnetic flux density. Herein, point P and point Q indicate magnetic flux densities measured at measurement positions X of −0.5 mm and 0.5 mm, respectively. And then, straight line A is drawn to connect point P and point Q. Subsequently, value D and value E, which are the magnetic flux densities at point P and point Q respectively, are evaluated. Next, slope α of straight line A ((E−D)/(0.5−(−0.5)) and Y-intercept β are evaluated, and then the expression of straight line A (Y=αX+β) is found.

Secondly, Y-axis value C of straight line A is calculated at each measurement point (e.g., at 0.05 mm intervals in measurement position X), while value B of the magnetic flux density (Y-axis value of the wave form of magnetic flux density) is measured at the same measurement point. Subsequently, an amount of shift (100×(B−C)/α) from straight line A at each measurement point is calculated as a numerical value (%). Thus, a linearity index is obtained by evaluating the maximum absolute value among the numerical values calculated at the respective measurement points.

Table 1 shows linearity indexes and slopes a of straight line A, which are calculated in the above manner, with respect to above Samples 1 to 3.

TABLE 1

| | linearity index | slope α of straight line |
|---|---|---|
| Sample 1 | 10.3% | 0.588 |
| Sample 2 | 2.2% | 0.101 |
| Sample 3 | 1.3% | 0.483 |

As obvious from Table 1, the working sample has a small linearity index as compared with the first and second comparative examples (Samples 1, 2). The small linearity index means that an amount of shift from the straight line is small and good linearity is obtained. Further, if magnetic flux density has good linearity in a waveform, a position detectable area will be enlarged.

On the other hand, slope a of straight line of the working sample (Sample 3) is much larger than that of the second comparative example (Sample 2), which has a good linearity in the comparative examples. This shows that the working sample has robustness against noises, which serve as an external factor. Consequently, the position detecting device of the present disclosure is obviously effective.

### INDUSTRIAL APPLICABILITY

The present disclosure is applicable to a position detecting device using a magnetic detection device. Specifically, the present disclosure is applicable to devices for performing position detection such as image stabilization mechanism in a digital still camera, valve deflection detecting mechanism in various kinds of devices for opening and closing a valve, and plunger control.

What is claimed is:

1. A position detecting device comprising:
a permanent magnet unit having magnetic pole areas of an N-pole and an S-pole in a surface thereof; and
a magnetic detection device that is apart from the surface of the permanent magnet unit by a distance,
wherein
the permanent magnet unit has a main magnet element, and an auxiliary magnet element that is located closer to the magnetic detection device than the main magnet element is,
the auxiliary magnet element has a N-pole auxiliary magnet part with the N-pole in a surface side, and a S-pole auxiliary magnet part with the S-pole in the surface side,
the main magnet element has an N-pole main magnet part on a side of the N-pole auxiliary magnet part, and an S-pole main magnet part on a side of the S-pole auxiliary magnet part,
the magnetic detection device is relatively movable in a direction tilted with respect to an area boundary plane that separates magnetic poles of a magnetic field generated by the permanent magnet unit, while keeping the distance from the permanent magnet unit, and
the N-pole auxiliary magnet part and the S-pole auxiliary magnet part are disposed apart from each other by a gap,
wherein
the gap is larger than a gap between the N-pole main magnet part and the S-pole main magnet part.

2. The position detecting device according to claim 1, wherein
the main magnet element and the auxiliary magnet element have substantially rectangular shaped cross sections in the direction tilted with respect to the area boundary plane.

3. The position detecting device according to claim 1, wherein
the main magnet element and the auxiliary magnet element each are constituted as a separate body.

4. The position detecting device according to claim 3, wherein
a separator is interposed between the main magnet element and the auxiliary magnet element.

5. The position detecting device according to claim 1, wherein:
the main magnet element are formed integrally and have a non-magnetized area located between the N-pole main magnet part and the S-pole main magnet part; and
the gap between the N-pole auxiliary magnet part and the S-pole auxiliary magnet part is larger than the non-magnetized area.

6. The position detecting device according to claim 1, wherein
the N-pole auxiliary magnet part is formed integrally with the N-pole main magnet part and the S-pole auxiliary magnet part is formed integrally with the S-pole main magnet part.

7. The position detecting device according to claim 1 further comprising:
a yoke disposed along an side of the permanent magnet unit that is reverse from the surface.

8. The position detecting device according to claim 1 further comprising:
a drive coil disposed along a side of the main magnet element that is reverse from a side thereof where the auxiliary magnet element is disposed.

9. An image stabilization device equipped with the position detecting device according to claim 1.
